(19) United States
(12) Patent Application Publication
(10) Pub. No.: US 2017/0322628 A1
(43) Pub. Date: Nov. 9, 2017

(54) AIRBORNE HAPTIC FEEDBACK DEVICE

(71) Applicants: Jamie Tan, West Lafayette, IN (US); Hong Z. Tan, West Lafayette, IN (US)

(72) Inventors: Jamie Tan, West Lafayette, IN (US); Hong Z. Tan, West Lafayette, IN (US)

(21) Appl. No.: 15/585,106

(22) Filed: May 2, 2017

Related U.S. Application Data
(60) Provisional application No. 62/332,157, filed on May 5, 2016.

(51) Int. Cl. G06F 3/01; G06F 1/16; G06F 3/0346

(52) U.S. Cl. CPC G06F 3/016; G06F 3/0346; G06F 1/163; G06F 3/017

(57) ABSTRACT

In a virtual or augmented reality system, a module with multiple contact points may provide haptic output associated with a virtual object being held or manipulated by a user's hand. A drone-like airborne device may keep such a module hovering close to the user and provide just-in-time contact and other types of haptic feedback when needed. The user experiences virtual objects with a head-mounted display and such a module that delivers multidimensional haptic feedback, including but not limited to, contact, surface stiffness, surface texture, and thermal properties of the virtual object that is in contact with the user's hand and fingers. The propellers on the drone device provide full six-degrees-of-freedom (6-DOF) force and torque feedback to the user via such a module attached to the airborne system. In some implementation, the user wears a wrist band that docks with such a module via magnets on both the wrist band and the module. The wrist band may contain multiple controls for the user to issue commands and communicate with the module. The position and movement of the module and the user's hand and fingers can be tracked by sensors that are either attached to the module or user (such as inertial measurement units, IMUs) or placed in the environment (such as cameras and laser range sensors).

### RELATED APPLICATIONS

This application claims the benefit of U.S. provisional patent application No. 62/332,157, filed May 5, 2016, entitled “Airborne Haptic (Force & Tactile) Feedback Device”, which is incorporated by reference herein in its entirety.

### FIELD OF THE INVENTION

The disclosure relates to the field of virtual reality and/or augmented reality.

### BACKGROUND OF THE INVENTION

There is a need for us to feel, as well as see and hear, in a virtual reality and/or augmented reality (VR/AR) environment. Current head-mounted displays do an adequate job of providing realistic-looking three-dimensional (3D) views of a virtual or augmented scene, and sometimes with compelling 3D sounds. None, however, provide force or tactile touch information to the person who is immersed in VR/AR. Thus, the user's sensory experience is incomplete.

There exist ways that haptic experience can be provided through simulated mechanical contacts. The simplest way is to have the user hold a controller and feel a buzz whenever an event happens. The buzz sensation is artificial, however, and using a controller to explore the world is not natural. Gloves or exoskeleton devices can be worn on the hand, arm, leg and torso, and can provide force and tactile feedback. Such solutions have the advantage of being wearable and therefore keep the user mobile, but the devices themselves are bulky and require the user to absorb reactive force on the shoulder or back, which can cause fatigue after some time.

Yet more compelling and realistic sensations can be provided through desktop or floor-mounted force/torque feedback devices which are capable of providing larger force and increased stiffness. It has been proposed that a force/torque display be positioned on a mobile robotic platform to enable haptic feedback in a freely movable space. However, such configurations require the user to be stationary in space. Another problem is that the reaction time of a robot to move its position is relatively slow and therefore does not provide realistic feedback. Yet another problem is that because the robot touches the floor near the user, and the user has his eyes covered by a headset that he wears on his head, the robot presents a tripping hazard.

### SUMMARY

In a virtual or augmented reality system, a module with multiple contact points may provide haptic output associated with a virtual object being held or manipulated by a user's hand. A drone-like airborne device may keep such a module hovering close to the user and provide just-in-time contact and other types of haptic feedback when needed. The user senses virtual objects with a head-mounted display and the module which delivers multidimensional haptic feedback, including but not limited to, contact, surface stiffness, surface texture, and thermal properties of the virtual object that is in contact with the user's hand and fingers. The propellers on the drone-like device provide full six-degrees-of-freedom (6-DOF) force and torque feedback to the user via such a module attached to the airborne system. In some embodiments, the user wears a wrist band that docks with the module via magnets on both the wrist band and the module. The wrist band may contain multiple controls for the user to issue commands and communicate with the module. The position and movement of the module and the user's hand and fingers can be tracked by sensors that are either attached to the module or user (such as inertial measurement units, IMUs) or placed in the environment (such as cameras and laser range sensors).

The present invention relates to a system and method for providing feedback information to a human operator in a virtual reality and/or augmented reality (VR/AR) environment. Particularly, this invention relates to touch-based (haptic) feedback in AR/VR. More particularly, this invention relates to providing haptic feedback without tethering the human operator with wearable devices. Specifically, this invention relates to an airborne haptic feedback system that comes into contact with the human operator at the appropriate time, the appropriate location, and with the appropriate force or tactile stimulation. This invention is further applicable to other applications where a machine tracks the position and movement of a person, and human-machine interaction occurs intermittently as required by the usage scenario. For example, an airborne device can follow a marathon runner and provide a drink to the runner when demanded. Another example is a flying tour-guide that leads the way in an unfamiliar environment. The flying tour-guide can present an image or video on an onboard display, play a sound, and/or let the tourist touch a virtual rendering of an artifact.

The invention may provide an airborne system that hovers over the user and comes into contact with the user only when the user touches an object in VR/AR. A drone-like airborne device may provide multidimensional haptic feedback that can be used in conjunction with a head-mounted display for VR/AR applications.

It is an object of the present invention to provide a method and system for the proper and safe delivery of haptic information to a human in VR/AR. It is also an object of the present invention to provide a method and a system that enables the human to explore virtual or augmented environments with a bare hand, untethered with controllers or any other devices. Another object of this invention is to have a convenient way to provide haptic information to not only the hand, but to any other body parts as dictated by the scenario of the VR/AR. Yet another object of this invention is to provide a commercially practical method for providing haptic feedback to the human. A further object of the present invention is to provide a general solution to any scenario where human-machine interaction is required intermittently in any indoor or outdoor environments.

In one embodiment, the invention comprises a housing having a spherical, cubic or other suitable shape, a set of propellers used to control the position and movement of the housing in the air, and movable parts inside the housing. The moving parts are actuated by motors mounted rigidly to the housing. The multiple moving parts are spaced so that their distal end portions are configured to be touched by multiple fingerpads on a hand of a user. When a user's hand touches, say, a virtual ball, the distal end portions of the moving parts may conform to a spherical surface. Thus, when the user sees an image of a ball through a head-mounted display (HMD) and touches the multiple end portions with the fingerpads, the user perceives that his/her hand has made contact with a virtual ball.

In another embodiment, the invention comprises a method of providing more than a contact point to each fingerpad. For example, the distal end portion of each moving part that makes contact with the fingerpad can include a small planar or laminate piece having a circular, square or other suitable two-dimensional (2-D) shape. The orientation of the planar or laminate piece can be controlled to be aligned with, co-planar with, or parallel to the tangent plane of the virtual object at the contact point. Using again the above example of touching a virtual ball, the local curvatures at the locations where fingerpads touch the ball depend on the contact locations. By making the orientations of the small planar or laminate contact pieces at the distal end of the moving parts co-planar with, or parallel to the tangent planes at the corresponding contact locations on the virtual ball, the user can better perceive the shape of the virtual ball.

In yet another embodiment, the invention comprises additional actuators at the distal end portions of the moving parts that provide the user with additional information about the virtual object being touched, including but not limited to, surface stiffness (or compliance), texture, thermal properties, etc. This may be accomplished by attaching vibrating actuators, foam pads of varying stiffness, Peltier devices, or other such mechanisms on the distal end portions of the moving parts that the user's fingerpads make contact with.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

A better understanding of the present invention will be had upon reference to the following description in conjunction with the accompanying drawings.

FIG. 1 is a perspective view of one embodiment of an airborne haptic feedback arrangement of the present invention.

FIG. 2 is an enlarged, perspective view of the wrist band of the airborne haptic feedback arrangement of FIG. 1.

FIG. 3 is a schematic, cross-sectional view of the hand module of the airborne haptic feedback arrangement of FIG. 1.

FIG. 4 is a plan view of an example embodiment of the tactile stimulator of the hand module of FIG. 3 for providing haptic output.

FIG. 5 is a block diagram depicting electronic components of an exemplary virtual/augmented reality system including the airborne haptic feedback arrangement of FIG. 1.

### DETAILED DESCRIPTION OF THE PREFERRED EMBODIMENTS

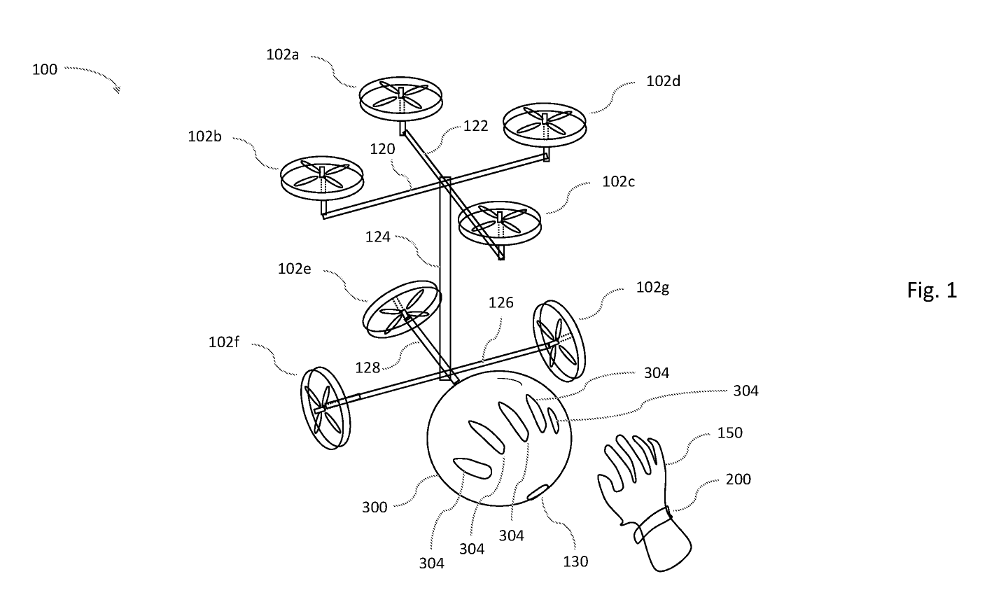

FIG. 1 illustrates one embodiment of an airborne haptic feedback arrangement 100 of the present invention, including a propeller assembly (102, 120-128) attached to a hand module 300, and a wrist band 200. The propeller assembly includes a frame (120-128) attached to seven propellers 102a-g which cooperate to propel hand module 300 in any desired direction. The top four propellers 102a-d are responsible for device levitation as well as providing vertical thrust that simulates force/torque feedback in vertical directions. The bottom three propellers 102e-g provide horizontal thrust that simulates force/torque feedback in horizontal directions. The combination of all propellers 102a-g can generate force/torque feedback in all directions and provide six degrees of freedom (6-DOF) force/torque feedback. Force and torque can be exerted by propellers 102a-g in any direction in the three-dimensional (3-D) space.

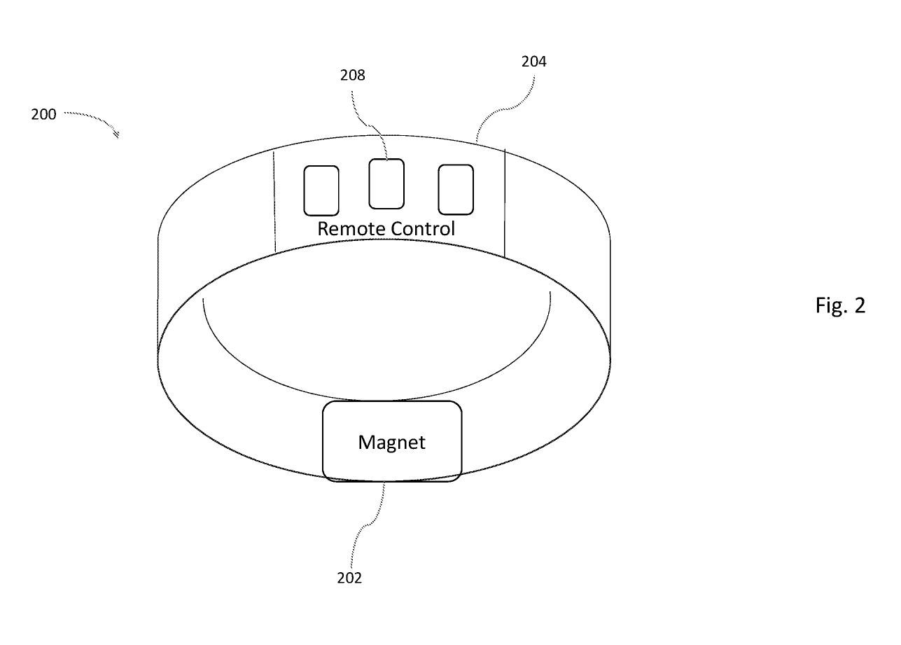

A user wears wrist band 200, which includes a magnet 202 (FIG. 2) and an electronic remote controller 204 that communicates with hand module 300. Magnet 202 attracts a magnet 130 on hand module 300 such that the user's hand 150 is docked with hand module 300 when arrangement 100 is in use. Remote controller 204 on wrist band 200 includes multiple pushbuttons 208 that can each be pressed to activate a respective predefined command.

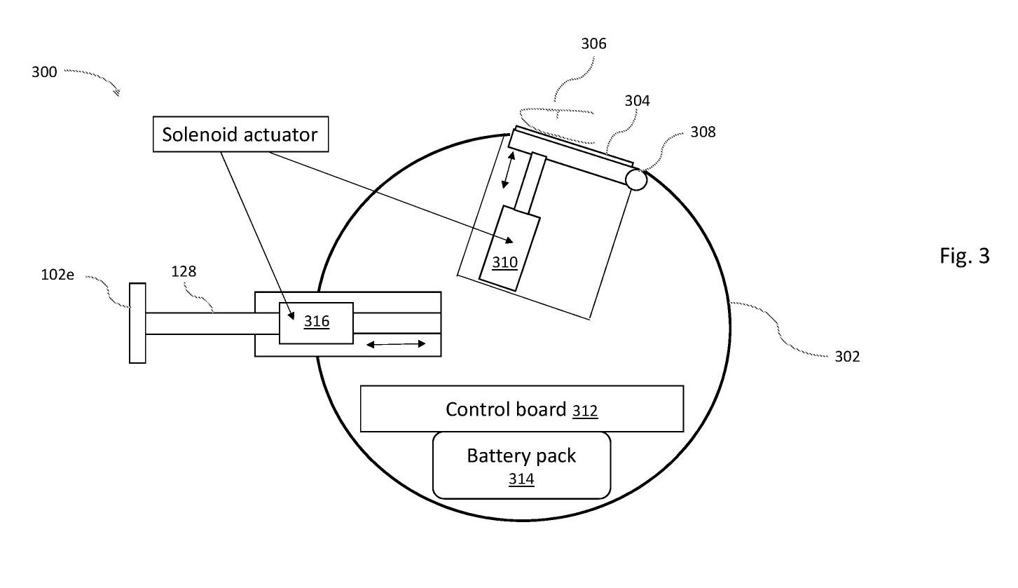

Hand module 300 includes a spherical housing 302 and five tactile stimulators 304 (FIG. 3) such that each finger 306 and thumb of the user's hand 150 can rest upon a respective one of tactile stimulators 304. Housing 302 includes a curved outer surface which supports and guides parts of the user's hand that do not engage tactile stimulators 304. Each tactile stimulator 304 may pivot around hinge 308 and extend less than one-half inch beyond the curved outer surface of housing 302. Each tactile stimulator 304 may be driven by a respective solenoid actuator 310 controlled by an electronic control board 312. Solenoid actuators 310 and control board 312 may be powered by battery pack 314.

Hand module 300 may be rigidly attached to part 128 of the propeller assembly. FIG. 3 illustrate one way that a horizontal force can be exerted on the hand module 300 by a solenoid actuator 316. This force can subsequently be exerted on the user's finger 306.

In addition to the force and/or torque exerted on the whole user's hand that rests on hand module 300 (e.g., on housing 302 and tactile stimulators 304), each finger experiences independent force feedback through the respective solenoid 310. In addition, the interface between the finger 306 and hand module 300 at tactile stimulator 304 can be moved by solenoid 310 to further provide location information to the finger. Solenoid 310 and tactile stimulator 304 can also convey stiffness information to the user's finger 306. Instead of a solenoid actuator, other types of motors including, but not limited to, DC brushed and brushless motors, can be used to the same effect.

Where each finger touches hand module 300, the tactile stimulator 304 can be simply a piece of rigid material that conveys contact information to the user's finger 306, or it can contain an actuator that generates a tactile stimulus. For example, eccentric rotary motors (ERMs), linear resonance actuators (LRAs) and piezoelectric actuators can be included in the tactile stimulator 304 to generate a tactile stimulus. The stimulus can be simply a vibration, or can be more nuanced to simulate surface hardness (e.g., by a predetermined transient vibratory signal that is delivered upon contact), or to simulate texture of the virtual surface (e.g., by a predetermined vibratory signal that is delivered when the user's finger 306 rubs the tactile stimulator 304).

Alternatively, the tactile stimulator 304 can contain one or more thin Peltier devices (i.e., thermoelectric actuators). They are solid-state active heat pumps that transfer heat from one side of the device to the other side, depending on the direction of an electric current. They are usually sandwiched between two ceramic plates to partially insulate the inside from the outer environment. The warm side of the Peltier device can be used to simulate the feel of a virtual cup containing hot coffee, and the cool side of the Peltier device can be used to simulate the feel of a cold ski pole.

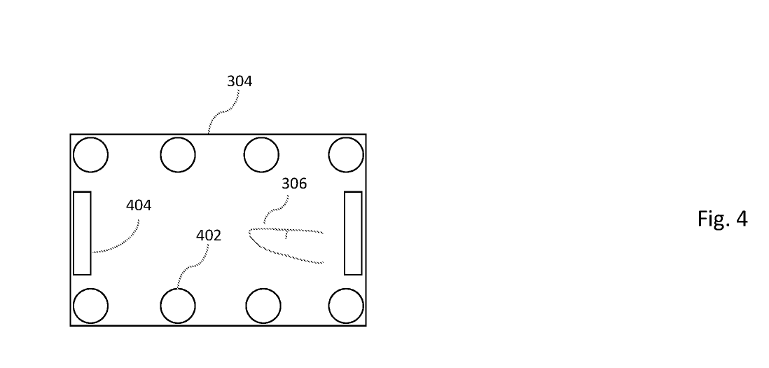

FIG. 4 illustrates an example embodiment of the tactile stimulator 304 for providing surface friction modulation. The surface of the tactile stimulator 304 is made of glass or any other material suitable for use with a touch input device. The surface friction of the glass can be modulated (e.g., increased and decreased) using actuators 402, 404 such as piezoelectric actuators, capable of inducing vibrations and other haptic feedback on the tactile stimulator 304 surface at a variable and controllable rate. As the user's finger 306 moves on the surface of the tactile stimulator 304, its position is read by a sensor (e.g., a touchscreen sensor) and the surface friction is modulated according to the surface property of the virtual surface being simulated. In some scenarios, the surface is made to feel rough to indicate such texture on the virtual surface. In other scenarios, the surface is made to feel smooth to indicate a smooth patch on the virtual surface. Furthermore, finger-press force can be read by a force sensor (e.g., a force-sensitive resistor sheet), and the surface friction level can be made to decrease as the finger 306 presses down to induce a sensation of a key click. This is useful for simulating the user's finger 306 pressing on a virtual button. The shape of the actuators 402 and 404 can be circular, oval, square, rectangular or any other suitable shape. Their placement can be along one or multiple edges of the surface of the tactile stimulator 304. This way, the tactile stimulator 304 is useful for simulating texture and key click on a virtual surface through surface friction modulation.

Hand module 300 can be built in different form factors depending on the applications. A spherical housing 302 is illustrated in FIGS. 1 and 3. In other embodiments, the hand module housing can be of the shape of a handle, a cylindrically-shaped cup, or a disk with only two finger units on each side. In one embodiment, there may be several hand modules of different shapes which may be swapped with each other. All hand modules may have the same interface to be attached to frame 128 so that the hand modules can be easily swapped with each other.

Instead of solenoid actuators 310, 316 and control board 312 being powered by battery pack 314, they may be powered by a battery placed in a holder carried by the user and connected to solenoid actuators 310, 316 and control board 312 through the contact between magnets 130, 202.

The position and movement of propeller assembly 102, 120-128 and hand module 300 can be tracked either by placing sensors on propeller assembly 102, 120-128 or hand module 300 (e.g., IMU—inertial measurement unit) or by using external sensors (e.g., RGB camera, laser range sensor, etc.) in the environment. This tracking may be used in guiding the airborne portion of arrangement 100 to stay close to the human user, and to bring the airborne portion into contact with the user whenever required by the use scenario. Having the sensors on the airborne portion itself enables the airborne portion to operate autonomously, although it does add weight to the airborne portion. When possible, the airborne portion can take advantage of the position tracking available in the AR/VR (e.g., the line-of-sight system used to track user head movement by an HTC VIVE headset).

In one embodiment, a sensor (not shown) detects a movement by the user. In particular, the sensor may detect movements and/or positions of each of the fingers of the user's hand. The sensor may be in the form of an infrared sensor that detects markers on each of the user's fingers. The sensor may also be in the form of a camera that captures images of the user's bare fingers. An electronic processor, such as processor on control board 312, may calculate positions of the user's finger based on the captured images. Dependent upon the detected or calculated positions of the user's fingers, the processor may cause propeller assembly 102, 120-128 to move the hand module 300 (e.g., housing 302 and/or tactile stimulators 304) relative to the user, or relative to the user's fingers.

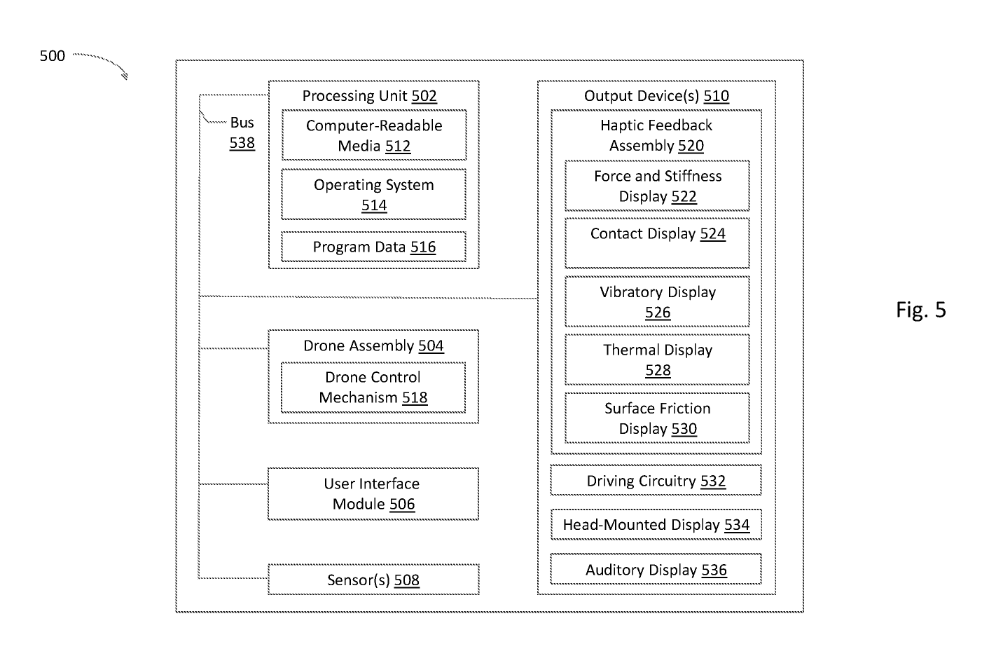

FIG. 5 is a block diagram of the components of an exemplary AR/VR system implementing airborne haptic feedback arrangement 100 of FIG. 1. The system includes a processing unit 502, a drone assembly 504, a user interface module 506, sensors 508, and multiple output devices 510. The processor 502 may reside anywhere on the propeller assembly frame 120-128, the control board 312, or in some cases the head-mounted display 534. The user interface 506 may include the remote control 204 and any other wired or wireless means for the user to communicate with the system. The sensors 508 may include position tracking devices such as cameras and laser range sensors in the space occupied by the AR/VR system, position and/or force sensors on the tactile stimulators 304, and position/orientation sensors integrated with any actuators such as the solenoid 310 and 316. The multiple output devices may include haptic displays 522-530 on the tactile stimulators 304, head-mounted display 534 worn by the user, and auditory display 536 in the form of either speakers in the space occupied by the AR/VR system or earphone/headset worn by the user. In some implementations, processor 502 is a microprocessing unit (MPU), a central processing unit (CPU), or other processing unit or component known in the art. Among other capabilities, processor 502 can be configured to fetch and execute computer-readable, processor-accessible instructions stored in computer-readable media 512 or other computer-readable storage media. The computer-readable media 512 may store an operating system 514, and may include program data 516. The program data 516 may include processing software that is configured to process signals received at the sensors 508 and user interface module 506. The program data 516 may also be configured to provide control signals to the drone control mechanism 518, and the driving circuitry 532 for actuating haptic displays 522, 524, 526, 528, 530. In addition to the aforementioned haptic displays, the output devices 510 may also include head-mounted display 534 and auditory display 536. All components may communicate via a network or a bus 538, in wired or wireless implementations.

The foregoing detailed description is given primarily for clearness of understanding and no unnecessary limitations are to be understood therefrom for modifications can be made by those skilled in the art upon reading this disclosure and may be made without departing from the spirit of the invention.

Although the techniques have been described in language specific to structural features and/or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, is understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A virtual reality arrangement, comprising:
a haptic feedback device configured to be touched by a human user; and
a propeller assembly attached to the haptic feedback device and configured to suspend the haptic feedback device in mid-air.

2. The arrangement of claim 1 further comprising:
a sensor configured to detect a movement by the user; and
an electronic controller coupled to the sensor and to the propeller assembly, the electronic controller being configured to:
receive a sensor signal from the sensor; and
cause the propeller assembly to move the haptic feedback device relative to the user dependent upon the sensor signal.

3. The arrangement of claim 1 wherein the propeller assembly is configured to move the haptic feedback device relative to the user.

4. The arrangement of claim 1 wherein the propeller assembly is configured to move the haptic feedback device to exert a force upon a body part of the user.

5. The arrangement of claim 1 wherein the haptic feedback device includes five tactile stimulators, each of the tactile stimulators being configured to provide tactile stimulation to a respective finger or thumb of a hand of the user.

6. The arrangement of claim 5 further comprising a housing including a curved outer surface and five throughholes in the curved outer surface, a respective said tactile stimulator extending through each said throughhole and extending less than a half-inch beyond the curved outer surface.

7. The arrangement of claim 5 further comprising five actuators, each said actuator being connected to and configured to drive a respective one of the tactile stimulators.

8. A haptic feedback device configured to be touched by a human user, the haptic feedback device comprising:
five tactile stimulators, each of the tactile stimulators being configured to provide tactile stimulation to a respective finger or thumb of a hand of the user;
a hand support including a curved outer surface and five throughholes in the curved outer surface, a respective said tactile stimulator extending through each said throughhole and extending less than a half-inch beyond the curved outer surface; and
five actuators, each said actuator being connected to and configured to drive a respective one of the tactile stimulators.

9. The haptic feedback device of claim 8 further comprising:
a sensor configured to detect a movement by the user; and
an electronic controller coupled to the sensor and to the actuators, the electronic controller being configured to:
receive a sensor signal from the sensor; and
cause the actuators to move the tactile stimulators dependent upon the sensor signal.

10. The haptic feedback device of claim 8 further comprising a torque sensor configured to detect a torque exerted by the user's hand on the tactile stimulators or on the hand support.

11. The haptic feedback device of claim 10 wherein the torque sensor comprises a gyroscope.

12. The haptic feedback device of claim 8 wherein the hand support comprises a housing having a substantially spherical outer surface.

13. The haptic feedback device of claim 8 wherein each of the five tactile stimulators has an actuate, elongate outer surface substantially concentric with the curved outer surface of the hand support.

14. The haptic feedback device of claim 8 further comprising a first magnet configured to be attracted to a second magnet worn on a wrist of the user.

15. A virtual reality arrangement, comprising:
a haptic feedback device including:
a tactile stimulator configured to provide tactile stimulation to a hand of the user;
a hand support including a curved outer surface and a throughhole in the curved outer surface, said tactile stimulator extending through said throughhole and extending beyond the curved outer surface; and
an actuator connected to and configured to exert a force on the tactile stimulator; and
a propeller assembly attached to the haptic feedback device and configured to:
suspend the haptic feedback device in mid-air; and
push the haptic feedback against the hand of the user.

16. The arrangement of claim 15 further comprising:
a sensor configured to detect a movement by the user; and
an electronic controller coupled to the sensor and to the propeller assembly, the electronic controller being configured to:
receive a sensor signal from the sensor; and
cause the propeller assembly to move the haptic feedback device relative to the user dependent upon the sensor signal.

17. The arrangement of claim 15 wherein the propeller assembly is configured to move the haptic feedback device relative to the user.

18. The arrangement of claim 15 wherein the haptic feedback device includes five tactile stimulators, each of the tactile stimulators being configured to provide tactile stimulation to a respective finger or thumb of a hand of the user.

19. The arrangement of claim 18 further wherein the hand support comprises a housing including a substantially spherical outer surface and five throughholes in the substantially spherical outer surface, a respective said tactile stimulator extending through each said throughhole and extending less than a half-inch beyond the curved outer surface.

20. The arrangement of claim 18 wherein the haptic feedback device further comprises five actuators, each said actuator being connected to and configured to drive a respective one of the tactile stimulators.
